(19) United States
(12) Patent Application Publication
(10) Pub. No.: US 2025/0390528 A1
(43) Pub. Date: Dec. 25, 2025

(54) DEEP CONTEXT ARTIFICIAL INTELLIGENCE ARCHITECTURE

(71) Applicant: SoundHound AI IP, LLC, Santa Clara, CA (US)

(72) Inventors: Tamer Abuelata, San Jose, CA (US); Keyvan Mohajer, Atherton, CA (US)

(73) Assignee: SoundHound AI IP, LLC, Santa Clara, CA (US)

(21) Appl. No.: 18/753,586

(22) Filed: Jun. 25, 2024

(51) Int. Cl. G06F 16/335; G06F 16/332

(52) U.S. Cl. CPC G06F 16/337; G06F 16/3329

(57) ABSTRACT

A deep context generative artificial intelligence (GAI) system personalizes and/or enhances responses provided by a GAI virtual assistant. The system includes a deep context service provider which collects and stores information regarding individual users. Upon building a datastore of a user's deep context information, that information may be embedded in each interaction with the GAI virtual assistant. By integrating the deep context information from the service provider into a powerful GAI virtual assistant, the virtual assistant is able to continuously refine and deepen its understanding of the user, allowing for a personalized and more human-like exchange with the AI virtual assistant and a rich user experience.

### FIELD

The present technology relates to a smart virtual assistant, and in particular to a smart virtual assistant where a generative artificial intelligence engine is personalized to individual users.

### BACKGROUND

Generative artificial intelligence (GAI) has great potential to advance human interaction with voice and digital assistants. Its enhanced natural language understanding and ability to generate natural, human-like responses to queries provides richer conversational interactions. However, at present, GAI voice and digital assistants are underutilized. One reason for this is that people prefer to interact with real or virtual assistants that know their information and/or history. Not only does this facilitate the interaction, but it builds in the user a sense of familiarity with the assistant.

The problem is that GAI systems lack the ability to remember personal information and preferences of individual users. Large language models and other GAI systems are trained on huge data sets over long periods of time and it is not feasible to retrain these models each time there is a need to include personal information and customized user context for different individuals. The result is that interactions with GAI systems, while rich in content, tend to provide a generic user experience, neglecting the unique preferences, nuances, and interaction patterns of individual users.

### DESCRIPTION OF THE DRAWINGS

FIG. 1 is a schematic representation of a deep context system according to embodiments of the present technology.

FIG. 2 is a first flowchart showing an explicit method for collecting context information from a user according to embodiments of the present technology.

FIG. 3 is a second flowchart showing an implicit method for collecting context information from a user according to embodiments of the present technology.

FIG. 4 is a third flowchart showing a further method for collecting context information from a user according to embodiments of the present technology.

FIG. 5 is a sample of a context database including different categories of deep context information for a user according to embodiments of the present technology.

FIG. 6 is a flowchart showing a first method for embedding context information into a query to personalize a response from a GAI engine according to embodiments of the present technology.

FIG. 7 is an illustration of a graphical user interface showing a user query presented to a GAI engine according to embodiments of the present technology.

FIG. 8 is an illustration of the query of FIG. 7 including embedded user context data that gets sent to the GAI engine according to embodiments of the present technology.

FIG. 9 is an illustration of a graphical user interface showing a personalized response to the input query of FIGS. 7 and 8 according to embodiments of the present technology.

FIG. 10 is an illustration of a graphical user interface showing a user query presented to a GAI engine according to embodiments of the present technology.

FIG. 11 is an illustration of the query of FIG. 10 including embedded user context data that gets sent to the GAI engine according to embodiments of the present technology.

FIG. 12 is an illustration of a graphical user interface showing an enhanced response to the input query of FIGS. 10 and 11 according to embodiments of the present technology.

FIG. 13 is an illustration of an automobile virtual assistant with a user voicing a user query according to embodiments of the present technology.

FIG. 14 is an illustration of the query of FIG. 13 including embedded user context data that gets sent to the GAI engine according to embodiments of the present technology.

FIG. 15 is an illustration of a graphical user interface showing a personalized response to the input query of FIGS. 13 and 14 according to embodiments of the present technology.

FIG. 16 is a flowchart showing a second method for embedding context information into a query to personalize a response from a GAI engine according to embodiments of the present technology.

FIG. 17 is a schematic block diagram of a computing environment according to embodiments of the present technology.

### DETAILED DESCRIPTION

The present technology will now be described with reference to the figures, which in general relate to a deep context AI architecture, where the user experience with an AI virtual assistant is personalized and enhanced according to the user's personal preferences. In embodiments, the architecture of the present technology includes a deep context service provider which collects and stores information regarding individual users. The term “deep context” as used herein refers to personalized information about an individual user, and it refers to enhanced information relating to current events and topics. This deep context information and data may be collected a number of ways, including by an explicit onboarding process and an implicit gathering of information and by storing and analyzing all AI virtual assistant queries, and possibly other online interactions, over time. The deep context service provider may further collect information by monitoring a user's client device. The user has the option to set a privacy level dictating how much deep context data is collected and stored.

Upon building a datastore of a user's deep context information, that information may be embedded in each interaction with an AI virtual assistant. By integrating the deep context information from the service provider into a powerful GAI virtual assistant, the virtual assistant is able to continuously refine and deepen its understanding of the user, allowing for a personalized and more human-like exchange with the AI virtual assistant and a rich user experience.

It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

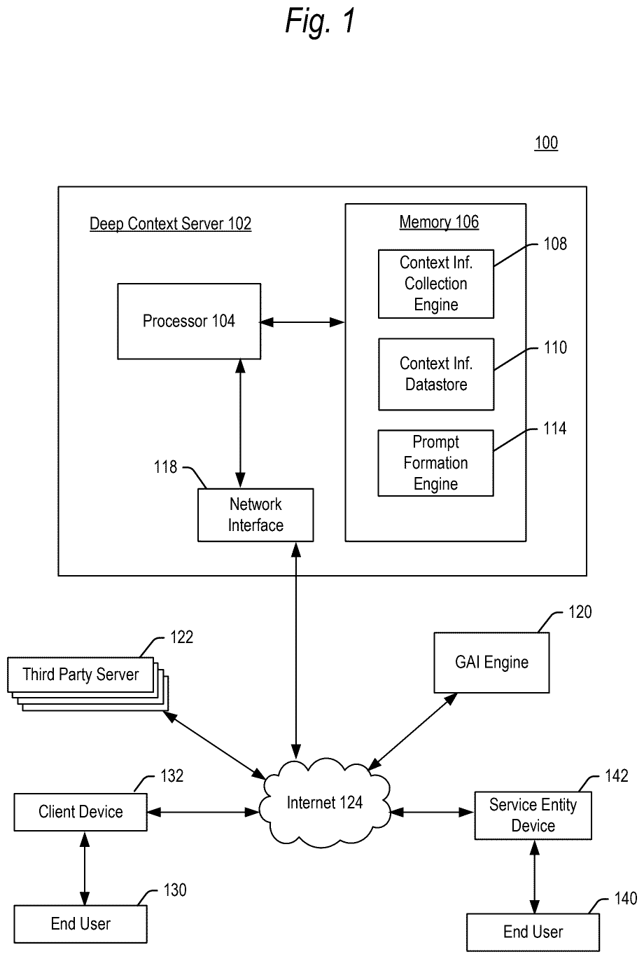

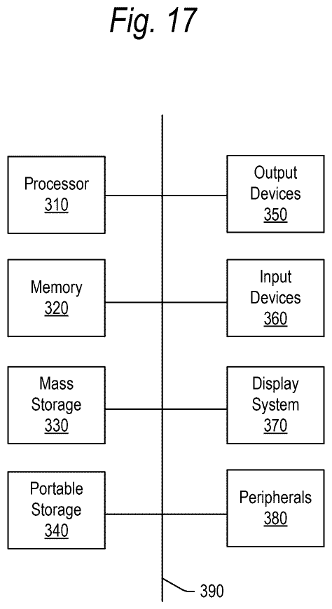

FIG. 1 is a schematic block diagram of a sample deep context architecture 100 for implementing the present technology. Architecture 100 may include a server owned or controlled by a deep context service provider, referred to herein as DCSP server 102. In further embodiments, server 102 may be comprised of multiple servers, collocated or otherwise. A more detailed explanation of a sample server 102 is described below with reference to FIG. 17, but in general, server 102 may include a processor 104 configured to control the operations of server 102, as well as facilitate communications between various components within server 102. The processor 104 may include a standardized processor, a specialized processor, a microprocessor, GPU or the like that may execute instructions for controlling server 102. As explained below, processor 104 may include, or be in communication with, a generative artificial intelligence engine 120 for performing a variety of functions, including the implementation of a GAI virtual assistant according to aspects of the present technology.

The server 102 may further include a memory 106 that may store algorithms that may be executed by the processor 104. According to an example embodiment, the memory 106 may include RAM, ROM, cache, flash memory, a hard disk, and/or any other suitable storage component. As shown in FIG. 1, in one embodiment, the memory 106 may be a separate component in communication with the processor 104, but the memory 106 may be integrated into the processor 104 in further embodiments.

Memory 106 may store various software application programs executed by the processor 104 for controlling the operation of the server 102. Such application programs may for example include a context information collection engine 108 and a GAI prompt formation engine 114. Memory 106 may further include a context information datastore 110. As explained in greater detail below, the context information collection engine 108 collects personalized information about individual users, which information is then stored in the context information collection datastore 110. This information is then used by the prompt formation engine 114 when a user interacts with GAI engine 120.

The DCSP server 102 may further include communications circuitry such as a network interface 118 for connecting to the Internet 124. The server 102 may include additional components for example as described below with respect to FIG. 17.

As mentioned, embodiments of the present technology use generative artificial intelligence (GAI), for example a large language model, as a virtual assistant handling user queries. In embodiments, the processor 104 may be in communication with a GAI engine 120 via the Internet 124. In further embodiments, the GAI engine 120 may be integrated into the processor 104 of DCSP server 102. GAI engine 120 receives an input, or prompt, and uses models and algorithms to generate an output including new, original content based on a given dataset on which engine 120 is trained. GAI engine 120 may be an existing generative neural network, such as GPT-3, GPT-4, or other known models. These models have been trained on extensive datasets and possess the ability to generate coherent and contextually relevant text based on provided input. In one example, the GAI engine 120 may be a large language model which may be trained and developed by the following steps.

Data Collection and Preprocessing: The GAI engine 120 may be provided with a diverse and extensive data set including a wide range of text from various sources, such as books, articles, websites, and more. The data may be preprocessed to ensure consistency, remove noise, and normalize the input format. The text may be broken down into smaller units, often words or subwords. Each unit may be assigned a unique identifier or token.

Model Architecture Selection: The GAI engine 120 may be configured in different model architectures, including for example a transformer architecture, generative adversarial network (GAN), a variational autoencoder (VAE), an autoregressive model, or other types of models designed for generative tasks. For large language models like GPT, the architecture is often based on the transformer architecture, which utilizes self-attention mechanisms. Self-attention mechanisms enable the model to weigh the importance of different words in a sequence when processing each word, allowing the model to capture relationships and dependencies between words more effectively.

Training the Model: The GAI engine 120 may then be trained using the prepared dataset. During training, the dataset may be divided into training, validation, and test sets. The training set is used to update the model parameters, the validation set is used to fine-tune hyperparameters and prevent overfitting, and the test set evaluates the model's generalization to unseen data. Using an optimization algorithm (e.g., stochastic gradient descent) the model parameters are iteratively updated based on the training data. The model is regularly evaluated based on the validation dataset to monitor its performance. The test set is used to assess the final performance and generalization of the model.

It is understood that the above steps for developing and training GAI engine 120 are by way of a summary example only and other or alternative steps may be used to develop and/or train a GAI engine 120 for use with the present technology. Training GAI engine 120 is a demanding task that requires significant computational resources, time, expertise, and careful management of the various training steps. This is one reason why it is not feasible to train GAI engines to be customized to the preferences and nuances of individual users.

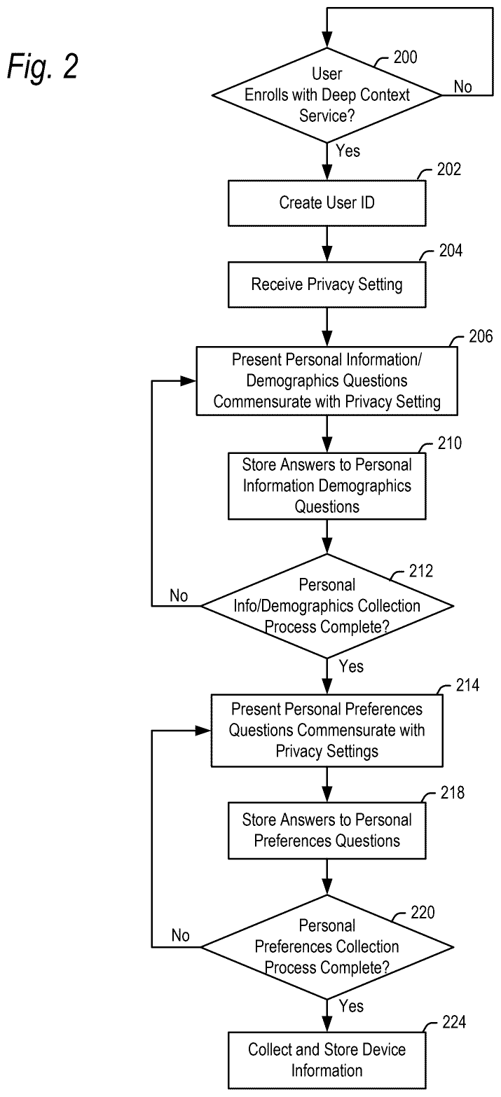

FIG. 2 is a flowchart showing the operation of the context information collection engine 108 for collecting information regarding individual users. The deep context personalization of the interaction with a GAI virtual assistant according to the present technology is a self-selecting process and users can opt in or opt out as they wish. In step 200, the context information collection engine 108 monitors whether a given user is looking to enroll in the deep context service through the DCSP server 102. If so, a user ID is created for the user in step 202, or an existing user ID for the user with the service provider is ported to the DCSP server 102.

In addition to users opting into or opting out of the personalization service, users can also set up privacy setting once they choose to opt in. This privacy setting for individual users may be set in step 204. In general, the privacy setting indicates the type and/or level of personalized information which will be stored and used by the present technology to personalize interactions with a GAI virtual assistant. In one example, the user may be given the option to set the privacy setting on a numeric scale, for example from 1 to 10.

In this embodiment, the DCSP server 102 may assign each category of collected information (or each item of information within a given category) a privacy level depending on how personal and private that category/item of information is. These privacy levels together with a user's selected privacy setting may then be used to determine what personal information is collected and used by the present technology to personalize interactions with a GAI virtual assistant. For example, a low privacy setting may mean that the context information engine 108 may collect and use a broad range of personal information regarding that user, including all categories/items of information having privacy level below some high threshold defined by the received privacy setting. A high privacy setting may alternatively mean that the context information engine 108 can only collect and use a narrow range of personal information regarding that user, including all categories/items of information having privacy level below some low threshold defined by the received privacy setting.

In a further embodiment, the user may be given the option to set the privacy setting for each item of information sought for collection by the context information collection engine 108. For example, as the engine 108 collects an item of information, the user may be prompted as to whether the system of the present technology can and should use this item of information when personalizing the interaction with the GAI virtual assistant. It is understood that the privacy setting received in step 204 may be configured to include alternative and/or additional features so that individual users can control the type and amount of personal information that is used in accordance with the present technology.

In steps 206-224, the context information collection engine 108 next collects information in accordance with the received privacy settings. FIG. 2 provides examples of an explicit onboarding information collection process performed by engine 108, but FIG. 2 is not meant to be exclusive, and other types of information may be explicitly collected. In step 206, the context information collection engine 108 presents the user with a variety of personal information and/or demographics questions commensurate with the received privacy setting. Following are examples of some questions which may be asked under this category.
Name
Home/Work Place Location
Age
Gender
Income
Ethnicity/Race
Preferred Language
Family/Relationship Status
Occupation
Education

It is understood that additional and/or alternative information may be sought for this category in further embodiments. Once collected, this information may be stored in the context information datastore in step 210. In step 212, the engine 108 determines whether there are additional personal information/demographics questions to present to the user. If so, the process of collecting and storing such information continues in steps 206 and 210.

If, on the other hand, there is no additional personal information/demographics questions in step 212, the engine 108 may next collect information as to the user's personal preferences in step 214, again commensurate with the privacy settings. These personal preference questions may for example fall into two categories: personal preferences as to how the user would prefer the GAI virtual assistant to present itself, and second, the user's own personal preferences. In collecting this information, the context information collection engine 108 may itself present the collected information to the GAI engine 120, which can aid in understanding the collected information and categorizing the collected information.

The first category of personal preferences may relate to how the user would prefer the GAI virtual assistant to present itself. In other words, what sort of personality would the user like the GAI assistant to have when interacting with the user. Examples of questions that the user may be asked in this class may include questions to determine the following personality traits of the GAI virtual assistant.
Ethnicity/Language
Voice (Male/Female)
Response Verbosity
Friendly/Informal vs. Formal/Professional
Humorous vs. Serious
Empathetic/Emotionally Supportive vs. Passive/Pragmatic

The context information collection engine may be set up to present the user with a variety of questions designed to illicit responses providing the above information. Other and/or alternative information may be sought under this category. Once collected, the information may be stored in the context information datastore 110.

In the second category, the context information collection engine 108 may present the user with questions to determine the user's own personal preferences. These questions may collect the following types of information regarding the user.
Hobbies/Interests
Entertainment Preferences
Restaurant/Culinary/Dietary Preferences
Fashion/Style Preferences
Travel Preferences.
Preferred News and Current Event Sources
Social Activities
Sports/Fitness
Health/Lifestyle Choices
Consumer Preferences
Technology Preferences
Arts Preferences
Political Preferences
Values/Beliefs/Religion

In addition to the user's preferences and likes, the collection engine 108 may also be set up to present the user with questions about things they do not like. Such questions may collect the following types of information regarding the user.
Foods/Allergies
Disagreeable Personal Habits
Political/Religious Disagreements
Pet Peeves

The context information collection engine may be set up to present the user with a variety of personal preference questions designed to illicit responses providing the above information. Other and/or alternative information may be sought under this category. This information may be used by the DCSP server 102 to better understand the user and guide the interaction with the GAI virtual assistant. The server 102 may also use this information as topics for the GAI virtual assistant to avoid altogether. This information may be stored in the context information datastore in step 218. In step 220, the engine 108 determines whether there are additional personal preferences questions to present to the user. If so, the process of collecting and storing such information continues in steps 214 and 218.

If, on the other hand, there are no additional personal preferences questions in step 220, the engine 108 may next collect information from the user's client device in step 224, again commensurate with the privacy settings. These devices may for example be the user's smart phone, laptop and/or desk top computers. The context information collection engine may use various APIs and cookies to gather information from the user's client device including for example the following information.
the user's Operating System
the user's network/wifi information
the user's IP Address
the user's GPS location
applications stored on the user's client devices
the user's browser history
the user's interaction history with social media applications

This information may further reveal characteristics, traits and nuances about the user. The above examples of information collected from a user's device are by way of example only, and there may be other and/or additional types of information which may be collected from a user's device, subject to their privacy level and access permissions for their device. As one further example, the client device may be able to capture information about its surrounding environment, which information may also be passed to the context information collection engine 108. For instance, where the client device is a computing device within an automobile, the computing device may be able to detect such things as ambient noise, number of people in the car, temperature, weather and whether the car is moving or stopped. At least some of this information may be captured and used to personalize an interaction with the automobiles virtual GAI assistant.

As noted, FIG. 2 provides an example where the context information collection engine 108 performs an express onboarding process with the user. It is understood that other and/or alternative questions may be expressly asked. As one such further example, the user may be asked questions from established personality tests, such as the Myers-Briggs Type Indicator test. Answers to these questions may be stored in datastore 110 and be used to further personal, enhance and nuance answers from the GAI virtual assistant. The express onboarding process may be performed all at once upon enrollment or in multiple sessions. Additionally, the onboarding process may be periodically repeated to update the collected context information.

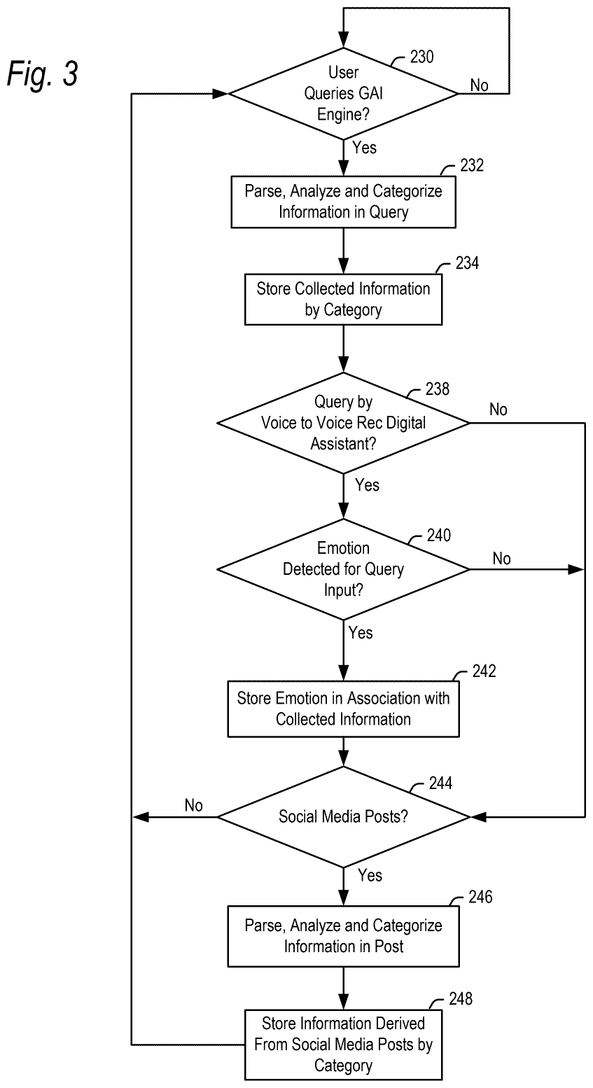

FIG. 3 shows a further example where the context information collection engine performs an implicit information collection process over time. In this embodiment, a user's queries to the GAI engine (and/or queries to other platforms) are collected, analyzed and categorized to glean user personal information, demographics and/or user preferences. In step 230, the context information collection engine 108 monitors for user queries to the GAI engine 120. The DCSP server 102 may have an API with GAI engine 120 so that enrolled users' queries are identified and captured in server 102.

In step 232, a captured query is parsed and analyzed to identify relevant information. Relevant information here is any information which has been defined as relating to a user's personal information or preferences. Upon identifying relevant information, that information may be categorized in step 234. The context information collection engine 108 may have algorithms for parsing analyzing and categorizing received queries. In further embodiments explained below, the engine 108 may use the GAI engine 120 to assist in parsing, analyzing and categorizing input queries.

It may happen that an input query is provided by voice in a voice recognition virtual assistant. Such input offers the possibility to glean additional information from an input query coming from characteristics of the voice input. For example, cadence, volume, pitch change and other voice patterns may be indicative of an emotion which can also be used by the present technology in personalizing a user's experience with a GAI virtual assistant.

In step 238, the context information collection engine 108 may check whether a query is received by voice. If so, the voice pattern may be analyzed using certain objective criteria stored on server 102 to look for an emotion from the voice pattern that can be associated with a given query input. A single instance of an emotion together with an input query may be insufficient to establish a link between the two, but the engine 108 may look for multiple instances of a given emotion for a given input query. Where a link between an emotion and information topic is detected, the context information collection engine 108 may identify the emotion and store it in association with the topic identified in the input query in step 242.

As noted above, the engine 108 may monitor user interactions with various third-party websites, including social media websites. In step 244, the engine 108 monitors whether a user has posted or otherwise interacted with a social media website. In step 246, a captured post is parsed and analyzed to identify relevant information; that is, any information which has been defined as relating to a user's personal information or preferences. Upon identifying relevant information, that derived information may be categorized and stored in step 248. As noted above, the context information collection engine 108 may use the GAI engine 120 to assist in parsing, analyzing and categorizing social media posts.

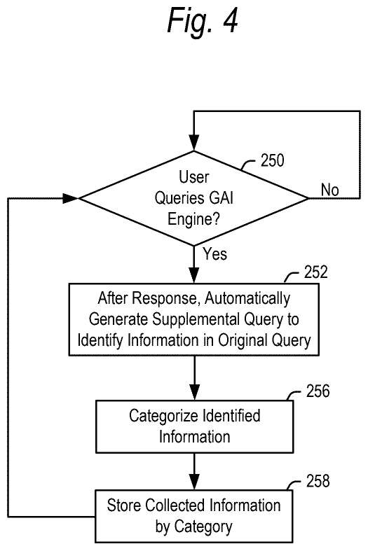

As noted above, the task of parsing, analyzing and categorizing information found in GAI input queries may be performed by algorithms in the context information collection engine 108. However, the GAI engine 120 is also a powerful tool which can be helpful in this process. FIG. 4 shows a flowchart where the GAI engine is used to help parse, analyze and categorize an input query to the GAI engine, or a query or post to a third-party website. In step 250, the context information collection engine 108 monitors for user queries to the GAI engine 120 (and/or other third-party websites). As noted above, the DCSP server 102 may have an API with GAI engine 120 (or other third-party websites) so that enrolled users' queries and posts are identified and captured in server 102. Where a query is captured as input to the GAI engine 120, the context information collection engine may reformulate that query and resubmit it for analysis to the GAI engine. The GAI engine 120 may return a response to the user on the original query, and the GAI engine 120 may return a response to the server 102 on the reformulated query.

For example, a user may input a query to GAI engine 120:

“What countries offer a good combination of skiing, good food and historical cultural sites?” [Query 1]

The GAI engine 120 will return a response to Query 1, possibly personalized in accordance with the present technology. However, in addition to that, the context information engine 108 may take Query 1, and reformulate it as supplemental query to obtain any personal information and/or preferences from the query. In this example, the context information collection engine 108 may take Query 1 and reformulate it as follows:

Extract from the following query all information related to the user's personal information and preferences: “What countries offer a good combination of skiing, good food and historical cultural sites.” [Query 2]

This supplemental query may be input to the GAI engine 120. The engine can parse and analyze the Query 1 portion of Query 2, and return any personal/preference information that can be gleaned from Query 1 to server 102. For example, the GAI engine 120 may return that the user likes skiing, enjoys good food, and is interested in historical cultural sites. These items of information may be categorized in step 256 and stored in step 258. Thereafter, any information learned from Query 1 may be used by the DCSP server 102 and GAI engine 120 for use in personalizing future queries. In a similar manner, the engine 108 may capture queries and/or posts to third-party websites other than GAI engine 120, take those queries/posts and reformulate them for input to the GAI engine to glean personal information and preferences.

The operation of the context information collection engine 108 according to any of the embodiments of FIGS. 2-4 may build a context datastore 110, an exemplary representation of which is shown in FIG. 5. FIG. 5 shows the generalized topics of information, which would in fact be customized for each individual and stored as separate user records in the context datastore 110. In embodiments, given the ability to consume standard, unstructured text, the information in datastore 110 may be stored as standard, unstructured text. However, the text may be structured (e.g., each entry structured as JSON or XML, separated into fields) in further embodiments.

As noted above, the datastore 110 may be populated with information for a given user a number of ways, including through an explicit onboarding process and an implicit information collection process overtime. Thus, the datastore may grow and be revised over time to most accurately reflect the personal information and preferences of a user. The types of information shown in the representation of datastore 110 in FIG. 5 are by way of example only, and it is understood that datastore 110 may store a wide variety of other and/or additional information in further embodiments.

In accordance with aspects of the present technology, the datastore 110 may be used during each interaction of a user with the GAI engine 120 to personalize the user experience with the GAI engine. In particular, when a user accesses the GAI engine and provides a query, the information from database 110 gets automatically embedded in the query as well as explained below. Thus, for each interaction with the GAI engine, the GAI engine has a rich understanding of the user and is able to personalize its interaction accordingly.

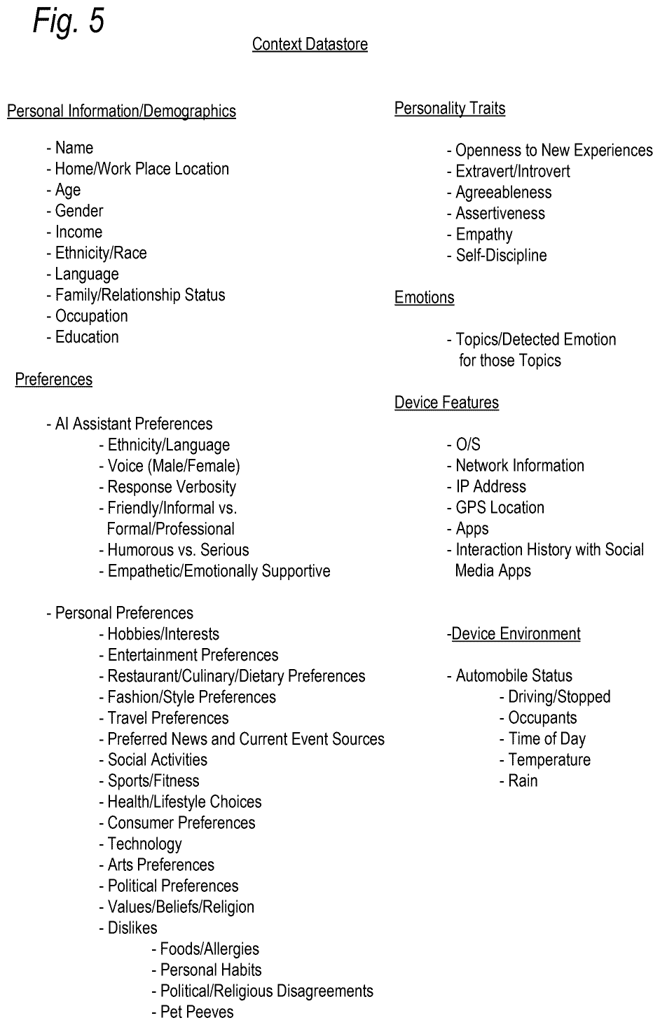

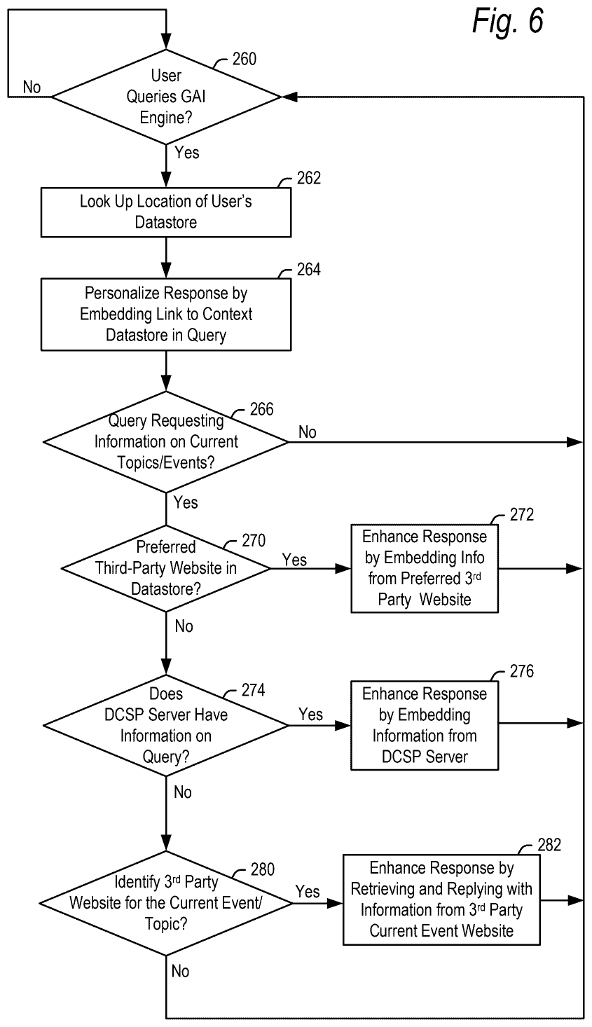

FIG. 6 is a flowchart illustrating the operation of the prompt formation engine 114 to supplement user prompts that are provided to GAI engine 120. In step 260, the engine 114 monitors for user queries to GAI engine 120. As noted above, the DCSP server 102 may have an API capable of monitoring when an enrolled user accesses and queries the GAI engine 120.

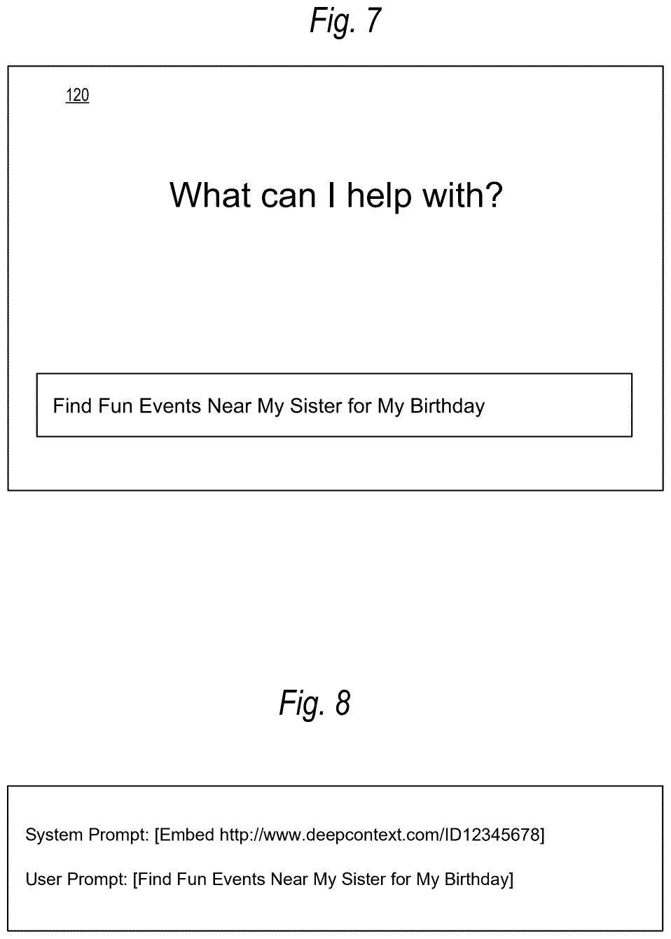

Upon detecting a user query to the GAI engine 120, the prompt formation engine 114 looks up a location of the user's context information database 110 in server 102 in step 262, and embeds a link to the user's context information datastore into the query in step 264. FIGS. 7-9 illustrate a simple example. In FIG. 7, the user has accessed the GAI engine 120 and entered the query:

“Find fun events near my sister for my birthday.”

Conventionally, GAI virtual assistants would have difficulty properly answering this query, as the GAI engine handling the query would have no context information about the user. However, in accordance with the present technology, in step 264, the GAI virtual assistant may be personalized by automatically embedding a system prompt together with the user prompt, where the system prompt includes a link to the user's personalized datastore 110. An example of embedding such a system prompt is shown schematically in FIG. 8. In FIG. 8, the system prompt includes a URL address to the user's personal datastore 110. In this example, the URL is shown as https://www.deepcontext.com/ID12345678. However, this is merely a sample URL, and a wide variety of other URL formats may be used to specify the querying user's datastore location.

Upon receiving the user prompt and the system prompt, the GAI engine 120 accesses and consumes the data in the user's context information datastore 110. In embodiments, the number of tokens which may be input with a query may be limited, and it may be necessary to upload only portions of the user's personal context information datastore. This embodiment is explained below. However, it may also happen that the GAI engine 120 is able to upload the entire datastore 110 and use its contents to personalize its response to the user.

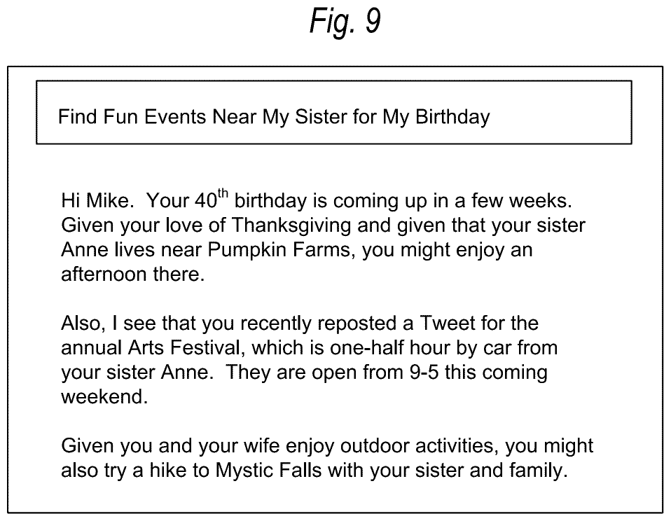

Upon receiving both the user prompt and the system prompt, the GAI engine is able to identify context information it can use to personalize its response. For example, the GAI engine 120 is able to identify personal information it determines is relevant to the query. The GAI engine is also able to discern certain likes and/or dislikes of the user from the various items of information stored in the user's datastore 110 that it determines are relevant to the query. Lastly, the GAI engine is able to discern the tone/personality that the user would like the GAI engine to assume. Thus, in one example, in response to the user's query, the GAI engine 120 may respond as follows as shown in FIG. 9.
Hi Mike. Your 40th birthday is coming up in a few weeks. Given your love of Thanksgiving and given that your sister Anne lives near Pumpkin Farms, you might enjoy an afternoon there.
Also, I see that you recently reposted a Tweet for the annual Arts Festival, which is one-half hour by car from your sister Anne. They are open from 9-5 this coming weekend.
Given you and your wife enjoy outdoor activities, you might also try a hike to Mystic Falls with your sister and family.

Such a response from GAI engine 120 has been personalized and enhanced in a number of ways, using the system prompt to the user's datastore 110. For example, the GAI virtual assistant provides a response in English, and has assumed a casual tone, with the phrase “Hi Mike.” Should the context information datastore 110 have indicated that the user prefers a more formal assistant tone, the response might have opened with “Hello Michael,” or “Hello Mr. Smith.”

The GAI engine 120 was also able to discern from context information datastore 110 personal information relevant to the query, such as that the user is a man, when the user's birthday is, that he has a sister and where the sister lives, and that he has a wife. The GAI engine 120 is further able to discern from context information datastore 110 likes and/or dislikes of the user, for example that the user likes Thanksgiving, arts festivals and that both he and his wife enjoy outdoor activities.

The sample response of FIG. 9 is also notable for what it does not include. For example, there may have been a popular lake nearby, but the user has indicated in his context information datastore 110 that he does not like swimming. Thus, this information was omitted from the response. The interaction of the GAI engine 120 with the context datastore 110 is transparent to the user. All the user sees is a rich, personal and nuanced response which builds in the user's mind a sense of trust and familiarity with the GAI virtual assistant.

As noted in the Background section, it is a shortcoming of conventional GAI engines that they are not easily updated with current events. It is therefore a feature of the present technology to not merely personalize a user experience with a GAI virtual assistant, but to also enhance the user experience by providing information on current topics and events.

Referring again to the flowchart in FIG. 6, in step 266, the query formation engine 114 next checks whether the query is requesting information on current topics or events. As noted above, the query may be parsed and analyzed either by algorithms on the DCSP server 102 and/or by the GAI engine 120 to determine what sort of current event/topic information is being requested. Moreover, the DCSP server 102 may know the date of release of the GAI engine 120, so that it can determine whether a user is requesting information on current topics/events from after that date. If so, in accordance with aspects of the present technology, the DCSP server 102 is able to assist by retrieving current event/topic information relevant to the query.

If the user is requesting current event/topic information for which the GAI engine has not been trained, the query formation engine 114 can retrieve this information from one or more of a number of different sources. The query formation engine 114 may first look in the context information datastore 110 in step 270 for external APIs and/or preferred third-party websites (e.g., those websites the user regularly visits or for which the user has otherwise indicated a preference) which are likely to have information relevant to the query. If one or more external APIs or preferred third-party websites 122 (FIG. 1) are identified in datastore 110 as having information relevant to the query, the information from those APIs/websites may be retrieved and embedded in a system prompt for the GAI engine 120 in step 272.

If no external APIs or preferred third-party websites are found in datastore 110 step 270, the query formation engine 114 may next determine in step 274 whether there are other datastores on, or associated with, DCSP server 102 itself which include current event/topic information related to the received query. In particular, the DCSP server 102, or servers associated therewith, may store as part of their normal operation information on certain current events and/or topics, such as for example news, weather, sports, entertainment, economy, etc. If one or more datastores on DCSP server 102 is/are identified as having information relevant to the query, this information may be retrieved and embedded in a system prompt for the GAI engine 120 in step 276.

On the other hand, if the query formation engine 114 determines that the DCSP server 102 does not have current event/topic information relevant to the query in step 274, the query formation engine 114 next checks in step 280 whether it is able to identify one or more external APIs and/or third-party websites 122 (not included in server 102) that includes current event/topic information relevant to the query. If so, the information from the one or more websites is retrieved and embedded in a system prompt for the GAI engine 120 in step 282.

Alternatively, if the query formation engine 114 is unable to identify relevant information in datastore 110, or on the DCSP server 102, or a third-party website in steps 270, 274 and 280, then no system prompt gets embedded related to the current event/topic information in the query to the GAI engine 120. In this event, the GAI engine 120 may respond that it has no information on this topic or event.

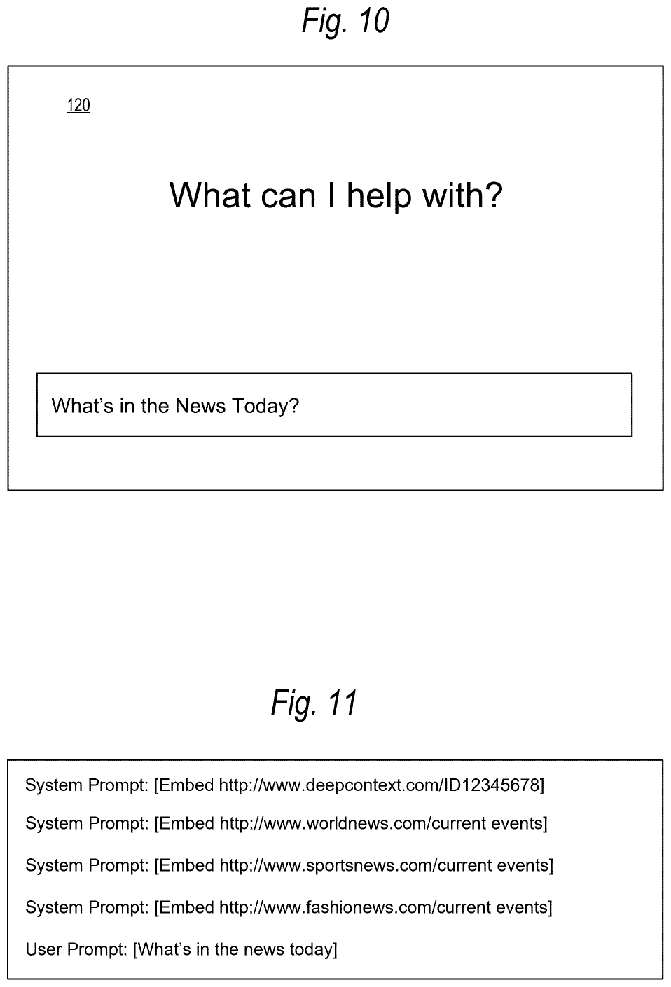

One of a wide variety of examples of enhancing a user experience with a GAI virtual assistant by adding current event information is shown in FIGS. 10-12. The user has queried the GAI engine 120 with:

“What's in the News Today?”

In response, the query formation engine 114 received the query, parsed and analyzed the query (by itself or with the assistance of GAI engine 120) and determined what the request relates to and that the GAI engine 120 will not have current information (as of the current date) to answer the query. The query formation engine then runs through steps 270-282 as described above. Referring to FIG. 11, the query formation engine 114 may analyze the context information datastore 110 and identify websites, for example from the user's browser history or social media posts, that user visits with a frequency above some predefined threshold. These websites may be considered preferred third-party websites.

In the example of FIG. 11, the query formation engine accessed the context information datastore 110 and identified three preferred websites, fictionally referred to herein as worldnews.com, sportsnews.com and fashionnews.com, each of which was identified to have information relevant to the current query “What's in the news today.” Accordingly, the query formation engine 114 may embed a system prompt linked to the user's context information database 110 as described above, as well as embedding information from the identified websites as system prompts to the GAI engine.

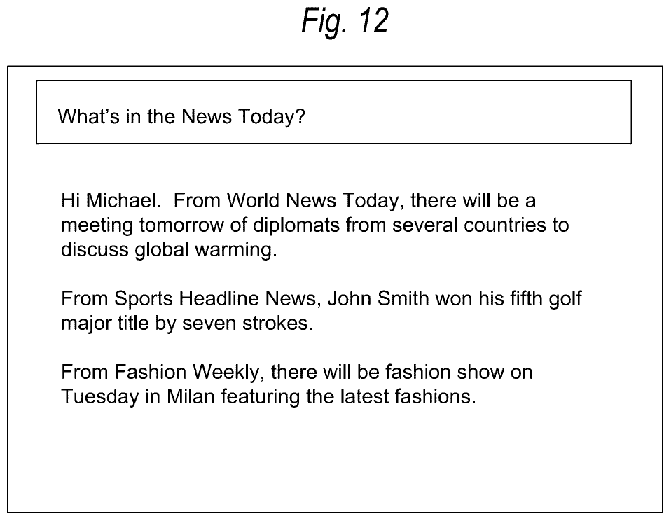

Upon accessing these websites, the GAI engine 120 may retrieve current events from these websites and reply to the user's query with something like the following as shown in FIG. 12.
Hi Michael. From World News Today, there will be a meeting tomorrow of diplomats from several countries to discuss global warming.
From Sports Headline News, John Smith won his fifth golf major title by seven strokes.
From Fashion Weekly, there will be fashion show on Tuesday in Milan featuring the latest fashions.

In some of the examples described above, the system prompt included embedded links to identified websites, and the GAI engine 120 accesses those websites to obtain the desired information. In further embodiments, as also noted above, instead of embedding the links, the server 102 may itself access the identified websites to obtain the desired current event information. Once that information is obtained by the engine 114, instead of embedding a link, the engine 114 may embed a system prompt including the current event/topic information it obtained from the third-party websites.

FIGS. 10-12 present one of a great many examples of the types of information which may be returned to personalize and/or enhance a user's interaction with a GAI virtual assistant. As noted, the query formation engine 114 may alternatively or additionally find information from other sources on server 102 and/or third party websites 122.

Referring now to the schematic representation of FIG. 1, the above-described interactions with the virtual assistant of GAI engine 120 took place directly between an end user 130 via his or her client device 132, such as for example a smart phone or laptop accessing a website of the GAI engine 120. In a further embodiment, an end user 140 may interact with a virtual assistant of GAI engine 120 via a service entity device 142. A common example of a service entity device 142 may be a computing system included within an automobile which performs a variety of functions, including connecting the end user 140 with the GAI engine 120.

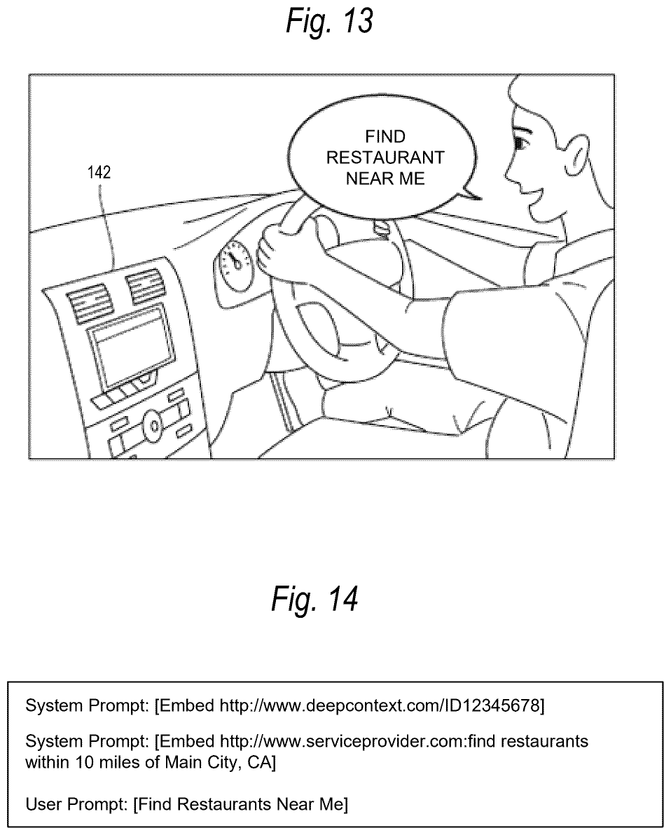

FIGS. 13-15 illustrate an example interaction with the GAI engine 120 through an automobile service entity device 142. In FIG. 13, the driver of an automobile engages the GAI engine 120 via the automobile's service entity device 142 to ask the query:

“Find restaurants near me.”

In accordance with the present technology, the GAI virtual assistant may provide a personalized response by automatically embedding one or more system prompts together with the user prompt in the query that gets sent to the GAI engine 120. An example of embedding such a system prompt is shown schematically in FIG. 14, including a system prompt including a URL address to the user's personal datastore 110 (shown schematically in FIG. 14). Upon analyzing the datastore 110, the query formation engine (by itself or in combination with the GAI engine 120) may identify a preference for a type of food, e.g., Italian food, as well as a post, stored in the datastore 110, that the user made to a social media website relating to the query, in this case a positive review for an Indian restaurant.

This particular query also asked about restaurants within a given geographic area (“near me”). Therefore, the query formation engine 114 (by itself or in combination with the GAI engine 120) may first determine where the user is from GPS data, and then the engine 114 may determine restaurants within a predefined radius of that position.

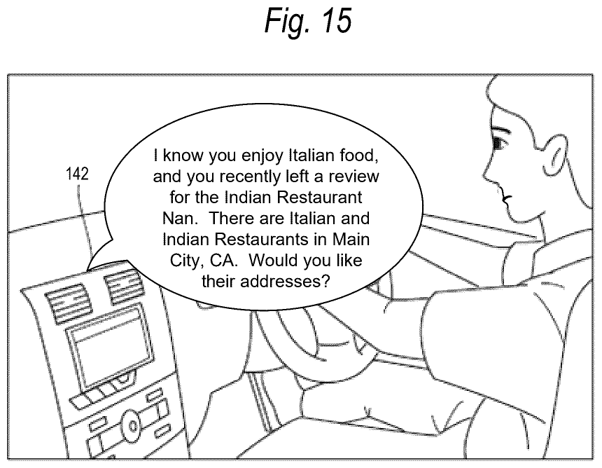

Upon receiving both the user prompt and the system prompt, the GAI engine is able to identify personal context information it can use to personalize its response. The GAI engine is also able to discern certain likes and/or dislikes of the user from the various items of information stored in the user's datastore 110 that it determines are relevant to the query. Lastly, the GAI engine is able to discern the tone/personality that the user would like the GAI engine to assume. Thus, in one example, in response to the user's query, the GAI engine 120 may respond as follows, as shown in FIG. 15.
I know you enjoy Italian food, and you recently left a review for the Indian Restaurant Nan. There are Italian and Indian Restaurants in Main City, CA. Would you like their addresses?

Such a response from GAI engine 120 has been personalized and enhanced in a number of ways, using the system prompt to the user's datastore 110. For example, the GAI virtual assistant provides a response in English, and has assumed a casual tone, using the familiar tone of speaking directly to the user. The GAI engine 120 is further able to discern likes and/or dislikes of the user, for example that the user likes Italian food and has posted for an Indian restaurant on a social media site. Again, the response may also be notable for what it does not include, excluding restaurants and/or food types that the user dislikes.

The service entity device 142 may be from other services in further embodiments. One further common example of a service entity device 142 may be a restaurant ordering server allowing end users 140 to order meals through an automated system at a restaurant, or through an automated system over a smart phone or other computing device remote from the restaurant.

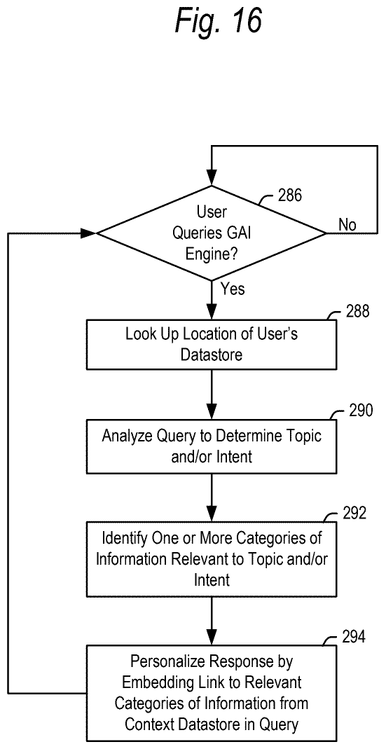

The above-described embodiments assume that there are no limitations on the size of the query input to the GAI engine 120, including system and user prompts. However, in embodiments, there may be such limitations, for example where the GAI engine limits queries to a predefined number of tokens. Such an embodiment will now be described with reference to FIG. 16. In step 286, the query formation engine 114 monitors for user queries to GAI engine 120. Upon detecting a user query to the GAI engine 120, the prompt formation engine 114 looks up a location of the user's context information database 110 in server 102 in step 288. In step 290, the query formation engine 114 (by itself or in combination with GAI engine 120) parses and analyzes the query to determine a meaning, topic and/or intent of the query.

In step 292, the query formation engine 114 (by itself or in combination with GAI engine 120) analyzes the categories of the context information datastore 110 to identify one or more categories that are relevant to the received query. In step 294, instead of simply embedding the entire datastore 110 as a system prompt, the query formation embeds only those portions of the datastore which were identified as being relevant to the query. In this way, the size of the system prompt and overall size of the query, may be limited and maintained within the predefined limits of the GAI engine 120.

FIG. 17 illustrates an exemplary computing system 300 that may be server 102 or server used to implement an embodiment of the present technology. The computing system 300 of FIG. 17 includes one or more processors 310 and main memory 320. Main memory 320 stores, in part, instructions and data for execution by processor unit 310. Main memory 320 can store the executable code when the computing system 300 is in operation. The computing system 300 of FIG. 17 may further include a mass storage device 330, portable storage medium drive(s) 340, output devices 350, user input devices 360, a display system 370, and other peripheral devices 380.

The components shown in FIG. 17 are depicted as being connected via a single bus 390. The components may be connected through one or more data transport means. Processor unit 310 and main memory 320 may be connected via a local microprocessor bus, and the mass storage device 330, peripheral device(s) 380, portable storage medium drive(s) 340, and display system 370 may be connected via one or more input/output (I/O) buses.

Mass storage device 330, which may be implemented with a magnetic disk drive or an optical disk drive, is a non-volatile storage device for storing data and instructions for use by processor unit 310. Mass storage device 330 can store the system software for implementing embodiments of the present invention for purposes of loading that software into main memory 320.

Portable storage medium drive(s) 340 operate in conjunction with a portable non-volatile storage medium, such as a external hard drive, external SSD or USB stick, to input and output data and code to and from the computing system 300 of FIG. 17. The system software for implementing embodiments of the present invention may be stored on such a portable medium and input to the computing system 300 via the portable storage medium drive(s) 340.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 17 includes output devices 350. Suitable output devices include speakers, printers, network interfaces, and monitors. Where computing system 300 is part of a mechanical client device, the output device 350 may further include servo controls for motors within the mechanical device.

Display system 370 may include a liquid crystal display (LCD) or other suitable display device. Display system 370 receives textual and graphical information, and processes the information for output to the display device.

Peripheral device(s) 380 may include any type of computer support device to add additional functionality to the computing system. Peripheral device(s) 380 may include a modem or a router.

The components contained in the computing system 300 of FIG. 17 are those typically found in computing systems that may be suitable for use with embodiments of the present invention and are intended to represent a broad category of such computer components that are well known in the art. Thus, the computing system 300 of FIG. 17 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, MacOS, FreeBSD, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, an SSD, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

In summary, one embodiment of the present technology relates to a system for personalizing a generative artificial intelligence (GAI) virtual assistant implemented by a GAI engine, the system comprising: one or more service provider servers configured to: collect information about an individual user; store the information about the individual user; receive a query directed to the GAI virtual assistant; and direct the GAI virtual assistant to personalize a response to the received query using the stored information about the individual.

In another example, the present technology relates to a system for personalizing a generative artificial intelligence (GAI) virtual assistant implemented by a GAI engine, the system comprising: one or more service provider servers, the one or more service provider servers comprising: a context information collection engine configured to collect information about an individual user; a context information datastore configured to store the information collected by the context information collection engine; and a query formation engine configured to receive a query directed to the GAI virtual assistant, and embed information in the query directing the GAI virtual assistant to personalize a response to the received query using the stored information about the individual.

In a further example, the present technology relates to a method of personalizing a response from a generative artificial intelligence (GAI) virtual assistant, comprising the steps of: (a) building a datastore of personal information and user preferences for individual users; (b) receiving a query to the GAI virtual assistant; and (c) directing the GAI virtual assistant to personalize the response to the query using the information in the datastore.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

1. A system for personalizing a generative artificial intelligence (GAI) virtual assistant implemented by a GAI engine, the system comprising:
one or more service provider servers configured to:
collect information about an individual user;
store the information about the individual user;
receive a query directed to the GAI virtual assistant;
filter the stored information based on a relevance of the stored information to the received query; and
direct the GAI virtual assistant to personalize a response to the received query using the filtered information about the individual.

2. The system of claim 1, wherein the one or more service provider servers collects the information expressly using questions in an onboarding operation.

3. The system of claim 1, wherein the one or more service provider servers collects the information implicitly by analyzing queries to the GAI virtual assistant.

4. The system of claim 1, wherein the one or more service provider servers collects the information implicitly by analyzing interactions with third-party websites other than the GAI engine.

5. The system of claim 1, wherein the one or more service provider servers collects the information implicitly by analyzing a client device communicating with the one or more service provider servers.

6. The system of claim 1, wherein the information collected by the one or more service provider servers comprises at least one of personal user information and demographic information.

7. The system of claim 1, wherein the information collected by the one or more service provider servers comprises user preferences as to his/her likes and dislikes.

8. The system of claim 1, wherein the information collected by the one or more service provider servers comprises user preferences as to desired personality traits of the GAI virtual assistant.

9. The system of claim 1, wherein the information collected by the one or more service provider servers comprises an emotion detected in a voice pattern where the query is received verbally.

10. The system of claim 1, wherein the one or more service provider servers are further configured to analyze the received query to determine what stored information may be used to personalize the response to the received query.

11. The system of claim 10, wherein the one or more service interacts with the GAI engine to assist in analyzing the received query to determine what stored information may be used to personalize the response to the received query.

12. The system of claim 1, wherein the one or more service provider servers are further configured to collect and provide information in answer to the query to the GAI virtual assistant where the query requests information from a timeframe after a training of the GAI engine.

13. A system for personalizing a generative artificial intelligence (GAI) virtual assistant implemented by a GAI engine, the system comprising:
one or more service provider servers, the one or more service provider servers comprising:
a context information collection engine configured to collect information about an individual user;
a context information datastore configured to store the information collected by the context information collection engine;
a filtering engine using the GAI assistant to filter the stored information to obtain a subset of the stored information determined to be relevant to the query; and
a query formation engine configured to receive a query directed to the GAI virtual assistant, and embed the subset of information in the query directing the GAI virtual assistant to personalize a response to the received query using the stored information about the individual.

14. The system of claim 13, wherein the query formation engine embeds a system prompt in the query to the GAI virtual assistant, the system prompt including a link to the information in the datastore.

15. The system of claim 13, wherein the query formation engine embeds a system prompt in the query to the GAI virtual assistant, the system prompt including the information in the datastore.

16. The system of claim 13, wherein the context information collection engine is further configured to analyze the query to identify at least one of user personal information and user preferences in the query, and to categorize any user personal information and user preferences identified in the query.

17. The system of claim 16, wherein the context information collection engine interacts with the GAI engine to assist in analyzing the received query to identify at least one of user personal information and user preferences in the query.

18. The system of claim 13, wherein the query formation engine is further configured to analyze the query to determine how the response may be personalized using the embedded information.

19. The system of claim 18, wherein the query formation engine interacts with the GAI engine to assist in analyzing the query to determine how the response may be personalized using the embedded information.

20. A method of personalizing a response from a generative artificial intelligence (GAI) virtual assistant, comprising the steps of:
(a) building a datastore of personal information and user preferences for individual users;
(b) receiving a query to the GAI virtual assistant;
(c) filtering the stored information based on a relevance of the stored information to the received query;
(d) directing the GAI virtual assistant to personalize the response to the query using the filtered information in the datastore.
